(19) United States
(12) Patent Application Publication
(10) Pub. No.: US 2022/0155888 A1
(43) Pub. Date: May 19, 2022

(54) STACKING STRUCTURE PREPARATION METHOD, STACKING STRUCTURE, AND TOUCH SENSOR

(71) Applicant: Cambrios Film Solutions Corporation, Tortola (VG)

(72) Inventors: Yi-Chen Tsai, Chiayi City (TW); Wei-Chia Fang, Zhubei City (TW); Chun-Hung Chu, Hsinchu City (TW); Chung-Chin Hsiao, Zhubei City (TW); Meng-Yun Wu, Yilan County (TW); Tsu-Hsuan Lai, New Taipei City (TW)

(21) Appl. No.: 17/098,511

(22) Filed: Nov. 16, 2020

(51) Int. Cl. G06F 3/041; H01B 1/02; B41F 5/24

(52) U.S. Cl. CPC G06F 3/041; G06F 2203/04103; B41F 5/24; H01B 1/02

(57) ABSTRACT

A stacking structure preparation method includes the steps of providing a substrate; printing a silver nanowire layer on the substrate using a flexographic printing process; and printing a meal layer on the substrate and the silver nanowire layer also using the flexographic printing process. The metal layer includes a metal mesh that covers at least a part of the substrate and the silver nanowire layer, and a plurality of metal traces that is connected to the metal mesh. A stacking structure formed through the above preparation method is also disclosed. The stacking structure includes, from bottom to top, a substrate, a flexo printed silver nanowire layer, and a flexo printed metal layer partially covering the substrate and the silver nanowire layer. The above preparation method and stacking structure can be applied to the manufacturing of a touch sensor.

### BACKGROUND

### 1. Field of the Disclosure

The present disclosure relates to a stacking structure preparation method, and more particularly, to a preparation method for forming a stacking structure through a flexographic printing process. The present disclosure also relates to a stacking structure, and more particularly, to a stacking structure formed through the flexographic printing process and including a metal layer having a metal mesh. The present disclosure also relates to a touch sensor that includes the above-mentioned stacking structure.

### 2. Description of the Related Art

A stacking structure including silver nanowires and metal layers can be applied to the manufacturing of a touch sensor. In a conventional method for preparing the stacking structure, a trace area (TA) and a viewable area (VA) are defined on a copper material and a nano-scale silver material through one step etching using photolithography. A first embodiment of a conventional stacking structure 10 formed using the above-mentioned preparation method is shown in FIGS. 1 and 2. As shown, the conventional stacking structure 10 includes a substrate 11, a silver nanowire layer 12 formed on a top of the substrate 11, and a metal layer 13 formed on a top of the silver nanowire layer 12. The metal layer 13 includes a metal sheet 131 and a plurality of metal traces 132; and the metal layer 13 is partially in direct contact with the substrate 11. A second embodiment of the conventional stacking structure 10 formed using the above-mentioned preparation method is shown in FIG. 3. As shown, in the second embodiment, the conventional stacking structure 10 includes a substrate 11, a silver nanowire layer 12 formed on a top of the substrate 11, and a metal layer 13 formed on a top of the silver nanowire layer 12. The metal layer 13 includes a metal sheet 131 and a plurality of metal traces 132, and the silver nanowire layer 12 is formed between the entire substrate 11 and the entire metal layer 13. In both embodiments, the conventional stacking structure 10 is divided into a trace area (TA), in which the metal traces 132 are formed; a first overlapped area 15, which may include a part of the metal sheet 131 that is located closer to the metal traces 132 as shown in the second embodiment; a second overlapped area 16, which includes the metal sheet 131 (as shown in the first embodiment) or another part of the metal sheet 131 that is located farther away from the metal traces 132 (as shown in the second embodiment); and a viewable area (VA), which is located adjacent to one side of the metal sheet 131 opposite to the trace area (TA) and is covered by the silver nanowire layer 12 but not by the metal sheet 131.

In the conventional stacking structure 10 formed using the prior art preparation method, the first overlapped area 15 and the second overlapped area 16 are formed of a uniform piece of solid copper material, which requires relatively complicated and expensive processing procedures. Therefore, it is desirable to develop an improved stacking structure preparation method, stacking structure, and touch sensor to overcome the drawbacks of the prior art.

### BRIEF SUMMARY

An objective of the present disclosure is to solve the problem of the relatively complicated and expensive prior art stacking structure preparation method by providing an improved stacking structure preparation method, and a stacking structure and a touch sensor manufactured using the same.

To achieve at least the above objective, the present disclosure provides a stacking structure preparation method, which includes:

providing a substrate;

printing a silver nanowire layer on a top of the substrate through a flexographic printing process; and

printing a metal layer on a top of the substrate and a top of the silver nanowire layer through the flexographic printing process, wherein the metal layer includes:

a metal mesh, which at least partially covers the substrate and the silver nanowire layer; and

a plurality of metal traces, which is connected to the metal mesh.

In the above preparation method, the metal layer is formed of a metal material selected from the group consisting of a copper material, a copper-nickel alloy, a copper-lead alloy, a silver material, a silver-nickel alloy, and a silver-lead alloy.

In the above preparation method, the substrate is formed of a material selected from the group consisting of polyethylene terephthalate (PET), cyclic olefin copolymer (COP), colorless polyimide (CPI), polyethylene naphthalate (PEN), polycarbonate (PC), and polyethersulfone (PES).

In the above preparation method, the silver nanowire layer has a thickness larger than 0.3 μm.

In the above preparation method, an area where the silver nanowire layer and the metal mesh overlap has a transmittance (T %) smaller than 90%.

To achieve at least the above objective, the present disclosure also provides a stacking structure, which includes:

a substrate;

a silver nanowire layer disposed on a top of the substrate; and

a metal layer disposed on the top of the substrate and a top of the silver nanowire layer, wherein the metal layer includes:

a metal mesh, which at least partially covers the substrate and the silver nanowire layer; and

a plurality of metal traces, which is connected to the metal mesh.

In the above stacking structure, the metal layer is formed of a metal material selected from the group consisting of a copper material, a copper-nickel alloy, a copper-lead alloy, a silver material, a silver-nickel alloy, and a silver-lead alloy.

In the above stacking structure, the substrate is formed of a material selected from the group consisting of polyethylene terephthalate (PET), cyclic olefin copolymer (COP), colorless polyimide (CPI), polyethylene naphthalate (PEN), polycarbonate (PC), and polyethersulfone (PES).

In the above stacking structure, the silver nanowire layer has a thickness larger than 0.3 μm.

In the above stacking structure, an area where the silver nanowire layer and the metal mesh overlap has a transmittance (T %) smaller than 90%.

In the above stacking structure, the stacking structure is divided into a trace area, which has the metal traces disposed therein; a first overlapped area, in which the metal mesh covers only the substrate without covering the silver nanowire layer; a second overlapped area, which is further divided into an opaque zone, in which the metal mesh covers the silver nanowire layer, and a transparent zone located adjacent to two opposite sides of the metal mesh and covered by the silver nanowire layer but not by the metal mesh; and a viewable area, which is located adjacent to one side of the metal mesh opposite to the trace area and is covered by the silver nanowire layer but not by the metal mesh.

In the above stacking structure, the transparent zone in the second overlapped area has a covering rate smaller than a covering rate of the opaque zone, and the covering rate of the transparent zone in the second overlapped area is smaller than 50%.

In the above stacking structure, the first overlapped area and the second overlapped area have an overall width smaller than 500 μm; and the first and the second overlapped area have a width-to-width ratio ranging between 0.1 and 10.

In the above stacking structure, the overall width of the first overlapped area and the second overlapped area ranges between 0.5 mm and 1.0 mm; and the width-to-width ratio of the first overlapped area and the second overlapped area ranges between 0.05 and 20.

In the above stacking structure, the overall width of the first overlapped area and the second overlapped area ranges between 1.0 mm and 1.5 mm; and the width-to-width ratio of the first overlapped area and the second overlapped area ranges between 0.03 and 30.

In the above stacking structure, the overall width of the first overlapped area and the second overlapped area ranges between 1.5 mm and 2.5 mm; and the width-to-width ratio of the first overlapped area and the second overlapped area ranges between 0.02 and 50.

In the above stacking structure, the metal mesh in the first overlapped area has a mesh line pitch, which is 0.1 to 10 times as large as a trace pitch of the metal traces.

In the above stacking structure, the metal traces have a trace pitch of 20 μm, a trace width of 10 μm, and a trace spacing of 10 μm, and the metal mesh in the first overlapped area has a mesh line pitch ranging between 2 μm and 200 μm.

In the above stacking structure, the metal mesh in the first overlapped area has a mesh line width ranging between 2 μm and 50 μm, and a mesh line spacing ranged between 2 μm and 10 μm.

In the above stacking structure, the metal mesh in the first overlapped area has a mesh line width/mesh line spacing selected from the group consisting of 40 μm/10 μm, 30 μm/10 μm, 20 μm/10 μm, and 10 μm/10 μm.

In the above stacking structure, the metal traces have a trace width ranging between 3 μm and 30 μm, and a trace spacing ranging between 3 μm and 30 μm.

The above stacking structure further includes a bonding pad disposed on the top of the substrate and includes a bonding metal mesh.

To achieve at least the above objective, the present disclosure also provides a touch sensor, which includes:

a stacking structure as described above; and

a cover layer disposed on a top of the metal layer in the aforesaid stacking structure.

The above touch sensor further includes:

a second silver nanowire layer disposed on a bottom of the substrate in the aforesaid stacking structure;

a second metal layer disposed on the bottom of the substrate and a bottom of the second silver nanowire layer; and

a second cover layer disposed on a bottom of the second metal layer, wherein the second metal layer includes:

a second metal mesh, which at least partially covers the bottom of the substrate and the second silver nanowire layer; and

a plurality of second metal traces, which is connected to the second metal mesh.

The stacking structure preparation method of the present disclosure has simplified procedures, so that the stacking structure manufactured using the same and the touch sensor including such a stacking structure can be produced at a largely reduced cost.

Further, the stacking structure and the touch sensor including the stacking structure manufactured according to the preparation method of the present disclosure reduce the consumption of metal materials to decrease the costs for forming the stacking structure and the touch sensor including such a stacking structure.

### BRIEF DESCRIPTION OF THE DRAWINGS

FIG. 1 is a schematic plan view of a conventional stacking structure.

FIG. 2 is a sectional view of the conventional stacking structure of FIG. 1.

FIG. 3 is a sectional view of another conventional stacking structure.

FIG. 4 is a flowchart showing the steps included in a stacking structure preparation method according to a first embodiment of the present disclosure.

FIG. 5 is a schematic view showing components included in an exemplary flexographic printing press.

FIG. 6 is a schematic plan view of a stacking structure according to a second embodiment of the present disclosure.

FIG. 7 is a sectional view of FIG. 6 taken along line A-A of FIG. 6.

FIG. 8 is a schematic plan view of a stacking structure according to a third embodiment of the present disclosure.

FIG. 9 is a cross-sectional view taken along line A-A of FIG. 8.

FIG. 10 is a cross-sectional view taken along line B-B of FIG. 8.

FIG. 11 is a cross-sectional view taken along line C-C of FIG. 8.

FIG. 12 is a cross sectional view taken along line D-D of FIG. 8.

FIG. 13 pictorially illustrates a touch sensor and a preparation method thereof according to a fourth embodiment of the present disclosure.

FIG. 14 pictorially illustrates a touch sensor and a preparation method thereof according to a fifth embodiment of the present disclosure.

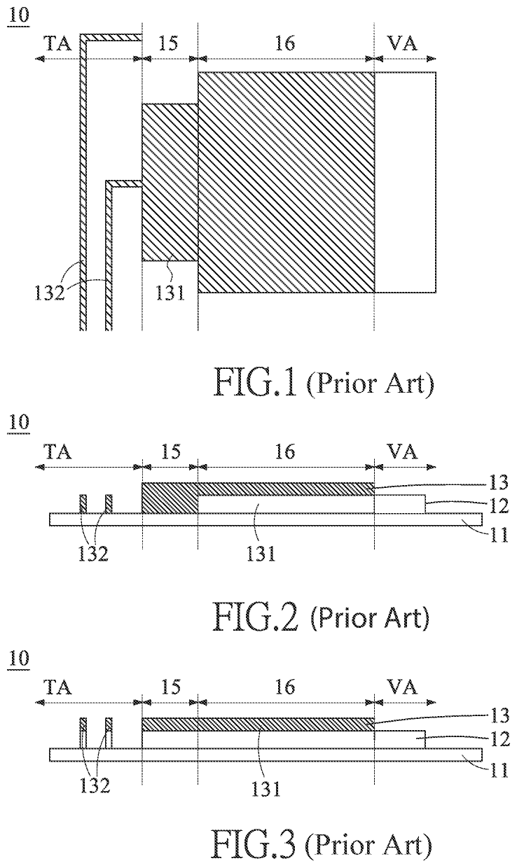

### DETAILED DESCRIPTION OF THE INVENTION

To facilitate understanding of the objects, characteristics, and effects of this present disclosure, embodiments together with the attached drawings for the detailed description of the present disclosure are provided. It is understood the present disclosure may also be implemented in other different embodiments, and numerous modifications and variations could be made to the details of the specification according to different viewpoints and applications without departing from the scope and spirit of the present disclosure.

In the specification and the appended claims, the use of the singular form of a word indicated by “a” or “the” shall construed to include the plural unless the context indicates otherwise.

In the specification and the appended claims, the use of the term “or” includes the meaning of “and/or” unless the context indicates otherwise.

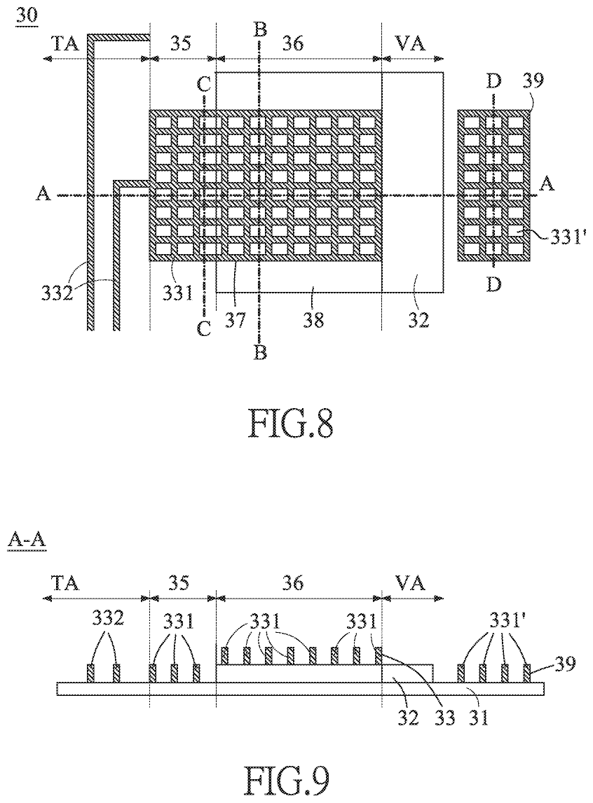

In the specification and the appended claims, the term “width” of the first overlapped area and of the second overlapped area indicates the width of the cross section of the first overlapped area and the second overlapped area, respectively, taken along line A-A of FIG. 8.

In the specification and the appended claims, the term “trace pitch” indicates the shortest distance between the centerlines of two parallelly adjacent metal traces; and the term “mesh line pitch” indicates the shortest distance between the centerlines of two parallelly adjacent metal lines in the metal mesh.

In the specification and the appended claims, the term “trace spacing” indicates the shortest distance between an edge of one metal trace and a facing edge of another parallelly adjacent metal trace; and the term “mesh line spacing” indicates the shortest distance between an edge of one metal mesh line and a facing edge of another parallelly adjacent mesh line.

### First Embodiment

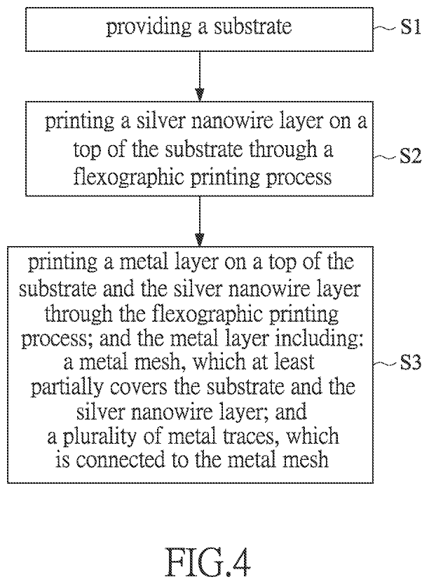

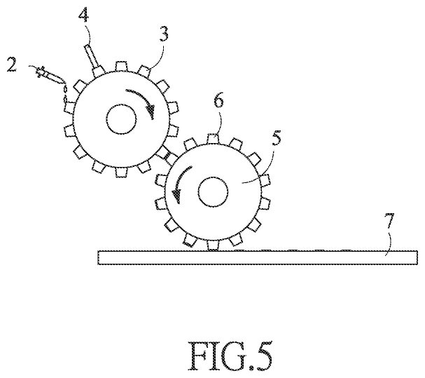

Please refer to FIG. 4, which is a flowchart showing the steps included in a stacking structure preparation method according to a first embodiment of the present disclosure. As shown, the preparation method includes a first step S1 of providing a substrate; a second step S2 of printing a silver nanowire layer on the substrate using a flexographic printing process; and a third step S3 of printing a metal layer on the substrate and the silver nanowire layer using the flexographic printing process. The metal layer includes a metal mesh, which at least partially covers the substrate and the silver nanowire layer, and a plurality of metal traces, which is connected to the metal mesh.

In the step S1 of the preparation method according to the first embodiment of the present disclosure, there is not any particular limitation with respect to the material for making the substrate. For example, materials suitable for making the substrate include, but are not limited to, polyethylene terephthalate (PET), cyclic olefin copolymer (COP), colorless polyimide (CPI), polyethylene naphthalate (PEN), polycarbonate (PC), and/or polyethersulfone (PES).

In the step S2 of the preparation method according to the first embodiment of the present disclosure, the conventional flexographic printing technology is employed to print the silver nanowire layer on the substrate. There is not any particular limitation with respect to the thickness of the silver nanowire layer, so long as the silver nanowire layer is able to provide an appropriate conductivity. For example, the silver nanowire layer may have a thickness larger than 0.3 μm.

In the step S3 of the preparation method according to the first embodiment of the present disclosure, the conventional flexographic printing technology is employed to print the metal layer on the substrate and the silver nanowire layer. There is not any particular limitation with respect to the composition of the metal layer, so long as the metal layer is able to provide an appropriate conductivity. For example, materials suitable for forming the metal layer include, but are not limited to, a copper material, a copper-nickel alloy, a copper-lead alloy, a silver material, a silver-nickel alloy, and/or a silver-lead alloy.

In the step S3 of the preparation method according to the first embodiment of the present disclosure, the metal layer that is printed includes a metal mesh, which at least partially covers the substrate and the silver nanowire layer, and a plurality of metal traces, which is connected to the metal mesh. With the above-described technical means, the stacking structure formed using the preparation method of the present disclosure has structural features as described in the following second embodiment of the present disclosure and can be applied to a touch sensor.

Preferably, in the stacking structure formed using the preparation method of the present disclosure, an area where the silver nanowire layer and the metal mesh overlap has a transmittance (T %) (i.e., a transmittance to visible light in the range of 400 nm to 700 nm) smaller than 90%.

Please refer to FIG. 5, which shows an example flexographic printing press usable in the steps S2 and S3 of the preparation method according to the first embodiment of the present disclosure. However, it is understood that the flexographic printing press in FIG. 5 is only illustrative, and the present disclosure is not necessarily limited thereto. As shown in FIG. 5, the exemplary flexographic printing press includes an ink dispenser 2, an anilox roller 3 onto which the ink dispenser 2 dispenses ink, a doctor blade 4 that removes any excessive ink from the anilox roller 3, a plate cylinder 5 in which a flexo plate 6 is provided around an outer circumferential surface of the plate cylinder 5, onto which the ink on the anilox roller 3 is transferred, and an object 7, onto which the ink on the flexo plate 6 is transferred to print a designed pattern.

### Second Embodiment

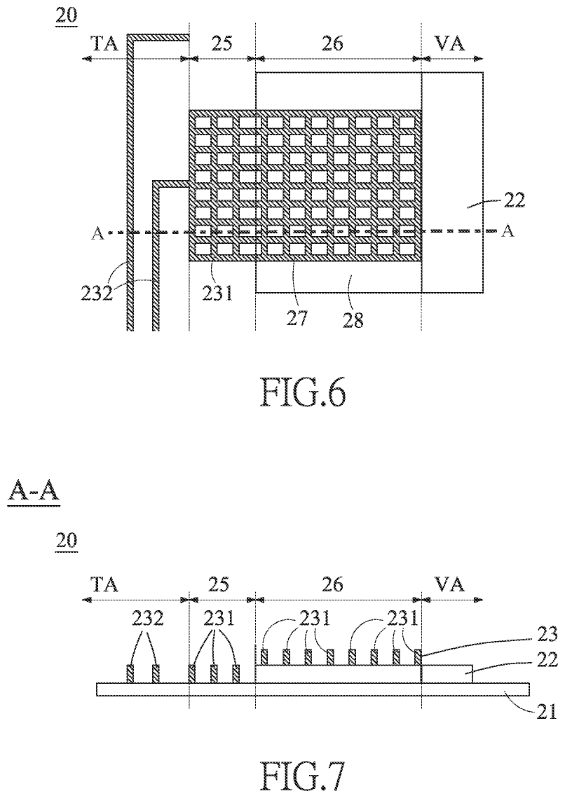

Please refer to FIGS. 6 and 7, in which a stacking structure 20 according to a second embodiment of the present disclosure is shown. As shown, the stacking structure 20 includes a substrate 21 (not shown in FIG. 6), a silver nanowire layer 22 formed on a top of the substrate 21, and a metal layer 23 formed on a top of the substrate 21 and the silver nanowire layer 22. The metal layer 23 includes a metal mesh 231, which at least partially covers the substrate 21 and the silver nanowire layer 22, and a plurality of metal traces 232, which is connected to the metal mesh 231.

In the second embodiment, the stacking structure 20 is divided into a trace area (TA), which has the metal traces 232 formed therein; a first overlapped area 25, in which the metal mesh 231 covers only the substrate 21 without covering the silver nanowire layer 22; a second overlapped area 26, which is further divided into an opaque zone 27, in which the metal mesh 231 covers the silver nanowire layer 22, and a transparent zone 28 located adjacent to two opposite sides of the metal mesh 231 and covered by the silver nanowire layer 22 but not by the metal mesh 231; and a viewable area (VA), which is located adjacent to one side of the metal mesh 231 opposite to the trace area (TA) and is covered by the silver nanowire layer 22 but not by the metal mesh 231.

In the stacking structure 20 according to the second embodiment of the present disclosure, there is not any particular limitation with respect to the material for making the substrate 21. For example, materials suitable for making the substrate 21 include, but are not limited to, polyethylene terephthalate (PET), cyclic olefin copolymer (COP), colorless polyimide (CPI), polyethylene naphthalate (PEN), polycarbonate (PC), and/or polyethersulfone (PES).

In the stacking structure 20 according to the second embodiment of the present disclosure, there is not any particular limitation with respect to the composition of the metal layer 23, so long as the metal layer 23 is able to provide an appropriate conductivity. For example, materials suitable for forming the metal layer 23 include, but are not limited to, a copper material, a copper-nickel alloy, a copper-lead alloy, a silver material, a silver-nickel alloy, and/or a silver-lead alloy.

In the stacking structure 20 according to the second embodiment of the present disclosure, there is not any particular limitation with respect to the thickness of the silver nanowire layer 22, so long as the silver nanowire layer 22 is able to provide an appropriate conductivity. For example, the silver nanowire layer 22 may have a thickness larger than 0.3 μm.

Preferably, in the stacking structure 20 according to the second embodiment of the present disclosure, an area where the silver nanowire layer 22 and the metal mesh 231 overlap has a transmittance (T %) smaller than 90%.

Preferably, in the stacking structure 20 of the second embodiment, the transparent zone 28 in the second overlapped area 26 has a covering rate smaller than that of the opaque zone 27, and the covering rate of the transparent zone 28 in the second overlapped area 26 is smaller than 50%. That is, the transparent zone occupies less than 50% of the total area of the second overlapped area 26.

Preferably, in the stacking structure 20 of the second embodiment, the first overlapped area 25 and the second overlapped area 26 have an overall width smaller than 500 μm, and the first overlapped area 25 and the second overlapped area 26 have a width-to-width ratio ranging between 0.1 and 10.

Preferably, in the stacking structure 20 of the second embodiment, the overall width of the first overlapped area 25 and the second overlapped area 26 ranges between 0.5 mm and 1.0 mm, and the width-to-width ratio of the first overlapped area 25 and the second overlapped area 26 ranges between 0.05 and 20.

Preferably, in the stacking structure 20 of the second embodiment, the overall width of the first overlapped area 25 and the second overlapped area 26 ranges between 1.0 mm and 1.5 mm, and the width-to-width ratio of the first overlapped area 25 and the second overlapped area 26 is ranges between 0.03 and 30.

Preferably, in the stacking structure 20 of the second embodiment, the overall width of the first overlapped area 25 and the second overlapped area 26 ranges between 1.5 mm and 2.5 mm, and the width-to-width ratio of the first overlapped area 25 and the second overlapped area 26 ranges between 0.02 and 50.

Preferably, in the stacking structure 20 of the second embodiment, the metal mesh 231 in the first overlapped area 25 has a mesh line pitch, which is 0.1 to 10 times as large as a trace pitch of the metal traces 232.

Preferably, in the stacking structure 20 of the second embodiment, the metal traces 232 have a trace pitch of 20 μm, a trace width of 10 μm, and a trace spacing of 10 μm, and the metal mesh 231 in the first overlapped area 25 has a mesh line pitch ranging between 2 μm and 200 μm.

Preferably, in the stacking structure 20 of the second embodiment, the metal mesh 231 in the first overlapped area 25 has a mesh line width ranging between 2 μm and 50 μm and a mesh line spacing ranging between 2 μm and 10 μm.

Preferably, in the stacking structure 20 of the second embodiment, the metal mesh 231 in the first overlapped area 25 has a mesh line width/mesh line spacing of 40 μm/10 μm, 30 μm/10 μm, 20 μm/10 μm, or 10 μm/10 μm.

Preferably, in the stacking structure 20 of the second embodiment, the trace width of the metal traces 232 ranges between 3 μm and 30 μm, and the trace spacing thereof ranges between 3 μm and 30 μm.

For example, the stacking structure 20 of the second embodiment can be formed using the preparation method according to the first embodiment of the present disclosure but is not limited thereto.

### Third Embodiment

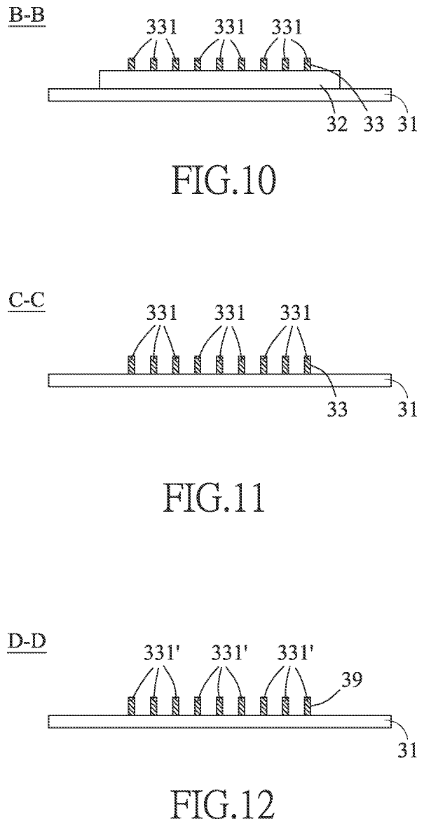

FIGS. 8 to 12 show a stacking structure 30 according to a third embodiment of the present disclosure, which includes a substrate 31 (not shown in FIG. 8), a silver nanowire layer 32 formed on a top of the substrate 31, and a metal layer 33 formed on a top of the substrate 31 and the silver nanowire layer 32. The metal layer 33 includes a metal mesh 331, which at least partially covers the substrate 31 and the silver nanowire layer 32, and a plurality of metal traces 332, which is connected to the metal mesh 331.

The stacking structure 30 according to the third embodiment of the present disclosure is divided into a trace area (TA), which has the metal traces 332 formed therein; a first overlapped area 35, in which the metal mesh 331 covers only the substrate 31 without covering the silver nanowire layer 32; a second overlapped area 36, which is further divided into an opaque zone 37, in which the metal mesh 331 covers the silver nanowire layer 32, and a transparent zone 38 located adjacent to two opposite sides of the metal mesh 331 and covered by the silver nanowire layer 32 but not by the metal mesh 331; and a viewable area (VA), which is located adjacent to one side of the metal mesh 331 opposite to the trace area (TA) and is covered by the silver nanowire layer 32 but not by the metal mesh 331.

Compared to the second embodiment, the stacking structure 30 according to the third embodiment of the present disclosure further includes a bonding pad 39, which is formed on the top of the substrate 31 and includes a bonding metal mesh 331′.

In the third embodiment, the bonding pad 39 can be used as a contact for connection to external circuits.

For example, the stacking structure 30 of the third embodiment can be formed using the preparation method according to the first embodiment of the present disclosure but is not limited thereto. In this case, the metal layer 33 and the bonding pad 39 in the stacking structure 30 of the third embodiment can be simultaneously formed in the same flexographic printing step S3 of the preparation method according to the first embodiment.

### Fourth Embodiment

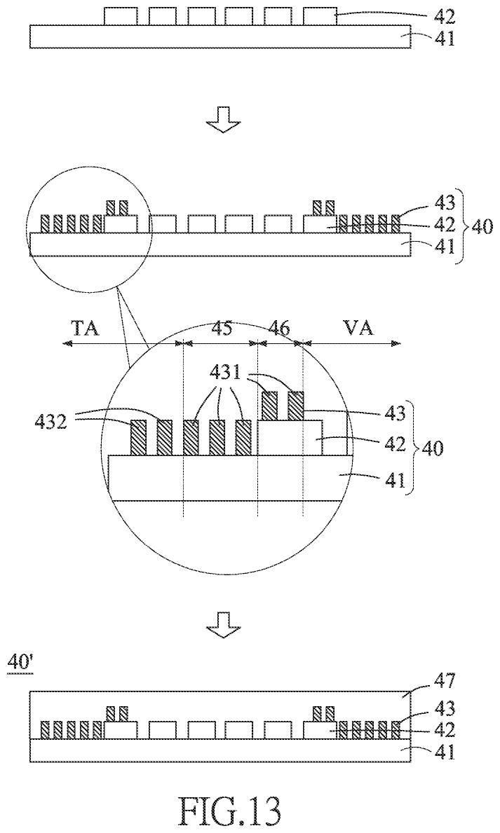

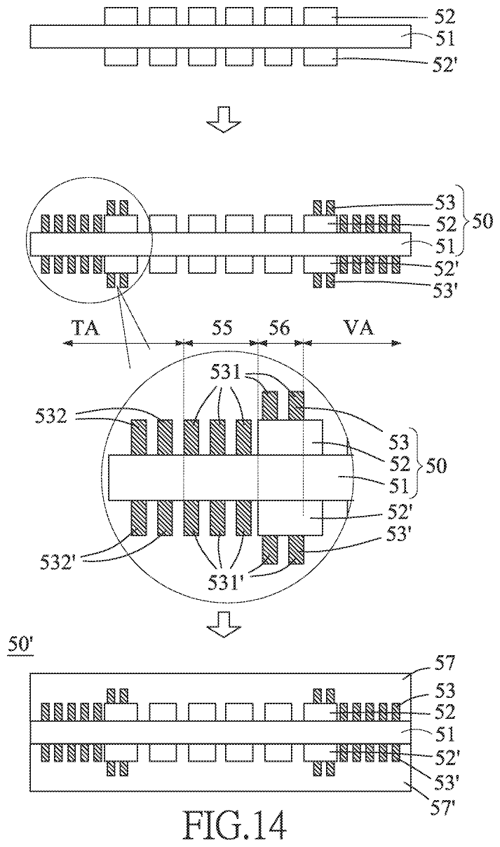

FIG. 13 pictorially illustrates a touch sensor 40′ and steps included in a preparation method thereof according to a fourth embodiment of the present disclosure. As shown, the touch sensor 40′ in the fourth embodiment includes a stacking structure 40, which is similar to the stacking structure 20 described in the second embodiment of the present disclosure.

In the touch sensor 40′ of the fourth embodiment, the stacking structure 40 includes a substrate 41, a silver nanowire layer 42 formed on a top of the substrate 41, and a metal layer 43 formed on a top of the substrate 41 and the silver nanowire layer 42. The metal layer 43 includes a metal mesh 431, which at least partially covers the substrate 41 and the silver nanowire layer 42, and a plurality of metal traces 432, which is connected to the metal mesh 431.

In the fourth embodiment, the stacking structure 40 is divided into a trace area (TA), which has the metal traces 432 formed therein; a first overlapped area 45, in which the metal mesh 431 covers only the substrate 41 without covering the silver nanowire layer 42; a second overlapped area 46, which is further divided into an opaque zone, in which the metal mesh 431 covers the silver nanowire layer 42, and a transparent zone located adjacent to two opposite sides of the metal mesh 431 and covered by the silver nanowire layer 42 but not by the metal mesh 431; and a viewable area (VA), which is located adjacent to one side of the metal mesh 431 opposite to the trace area (TA) and is covered by the silver nanowire layer 42 but not by the metal mesh 431.

Compared to the second embodiment, the stacking structure 40 of the touch sensor 40′ according to the fourth embodiment of the present disclosure further includes a cover layer 47, which is formed on the metal layer 43.

FIG. 13 shows example steps included in the preparation method for forming the touch sensor 40′ according to the fourth embodiment of the present disclosure. As shown, the method includes the steps of providing a substrate 41;

printing a silver nanowire layer 42 on the substrate 41 using a flexographic printing process; printing a metal layer 43 on the substrate 41 and the silver nanowire layer 42 using the flexographic printing process; and forming a cover layer 47 on a top of the metal layer 43. The metal layer 43 includes a metal mesh 431, which at least partially covers the substrate 41 and the silver nanowire layer 42, and a plurality of metal traces 432, which is connected to the metal mesh 431.

### Fifth Embodiment

FIG. 14 pictorially illustrates a touch sensor 50′ and steps included in a preparation method thereof according to a fifth embodiment of the present disclosure. As shown in FIG. 14, the touch sensor 50′ in the fifth embodiment includes a stacking structure 50, which is similar to the stacking structure 20 described in the second embodiment of the present disclosure.

In the touch sensor 50′ of the fifth embodiment, the stacking structure 50 includes a substrate 51, a silver nanowire layer 52 formed on a top of the substrate 51, and a metal layer 53 formed on a top of the substrate 51 and the silver nanowire layer 52. The metal layer 53 includes a metal mesh 531, which at least partially covers the substrate 51 and the silver nanowire layer 52, and a plurality of metal traces 532, which is connected to the metal mesh 531.

In the fifth embodiment, the stacking structure 50 is divided into a trace area (TA), which has the metal traces 532 formed therein; a first overlapped area 55, in which the metal mesh 531 covers only the substrate 51 without covering the silver nanowire layer 52; a second overlapped area 56, which is further divided into an opaque zone, in which the metal mesh 531 covers the silver nanowire layer 52, and a transparent zone located adjacent to two opposite sides of the metal mesh 531 and covered by the silver nanowire layer 52 but not by the metal mesh 531; and a viewable area (VA), which is located adjacent to one side of the metal mesh 531 opposite to the trace area (TA) and is covered by the silver nanowire layer 52 but not by the metal mesh 531.

Compared to the second embodiment, the stacking structure 50 of the touch sensor 50′ according to the fifth embodiment of the present disclosure further includes a cover layer 57, which is formed on a top of the metal layer 53.

Compared to the fourth embodiment, the stacking structure 50 of the touch sensor 50′ according to the fifth embodiment of the present disclosure further includes a second silver nanowire layer 52′ formed on a bottom of the substrate 51; a second metal layer 53′ formed on a bottom of the substrate 51 and the second silver nanowire layer 52′; and a second cover layer 57′ formed on a bottom of the second metal layer 53′. The second metal layer 53′ includes a second metal mesh 531′, which at least partially covers the substrate 51 and the second silver nanowire layer 52′, and a plurality of second metal traces 532′, which is connected to the second metal mesh 531′.

FIG. 14 shows example steps included in the preparation method for forming the touch sensor 50′ according to the fifth embodiment of the present disclosure. As shown, the method includes the steps of providing a substrate 51; printing a silver nanowire layer 52 and a second silver nanowire layer 52′ on a top of the substrate 51 and a bottom of the substrate 51, respectively, at the same time using a flexographic printing process; printing a metal layer 53 on a top of the substrate 51 and the silver nanowire layer 52 using the flexographic printing process and printing a second metal layer 53′ on a bottom of the substrate 51 and the second silver nanowire layer 52′ using the flexographic printing process;

forming a cover layer 57 on a top of the metal layer 53; and forming a second cover layer 57′ on a bottom of the second metal layer 53′. The metal layer 53 includes a metal mesh 531, which at least partially covers the substrate 51 and the silver nanowire layer 52, and a plurality of metal traces, which is connected to the metal mesh 531. The second metal layer 53′ includes a second metal mesh 531′, which at least partially covers the substrate 51 and the second silver nanowire layer 52′, and a plurality of second metal traces 532′, which is connected to the second metal mesh 531′.

In brief, the stacking structure preparation method, the stacking structure, and the touch sensor according to the present disclosure provide at least the following advantageous effects:
(1) In the stacking structure preparation method of the present disclosure, the flexographic printing technology is employed to print the silver nanowire layer and the metal layer sequentially to eliminate the conventional photolithography process that is complicated and expensive. Therefore, the stacking structure preparation method of the present disclosure has simplified procedures to largely reduce the preparation cost of the stacking structure. The method of the present disclosure can be applied to the manufacturing of touch sensors, so that touch sensors including the stacking structure of the present disclosure can be produced at a reduced cost.
(2) The stacking structure according to the present disclosure includes a metal layer having a metal mesh, which makes the stacking structure and the touch sensor having such the stacking structure be uniquely dividable into a first overlapped area and a second overlapped area. Compared to the conventional metal sheet materials, the metal mesh can advantageously reduce the consumption of metal materials to decrease the costs for forming the stacking structure and the touch sensor having such a stacking structure. In this manner, it is possible to realize a square touch sensor.

While the present disclosure has been described by means of specific embodiments, numerous modifications and variations could be made thereto by those skilled in the art without departing from the scope and spirit of the present disclosure set forth in the claims.

What is claimed is:

1. A stacking structure preparation method, comprising:
providing a substrate;
printing a silver nanowire layer on a top of the substrate through a flexographic printing process; and
printing a metal layer on the top of the substrate and a top of the silver nanowire layer through the flexographic printing process, wherein the metal layer comprises:
a metal mesh, which at least partially covers the substrate and the silver nanowire layer; and
a plurality of metal traces, which is connected to the metal mesh.

2. The stacking structure preparation method according to claim 1, wherein the metal layer is formed of a metal material selected from the group consisting of a copper material, a copper-nickel alloy, a copper-lead alloy, a silver material, a silver-nickel alloy, and a silver-lead alloy.

3. The stacking structure preparation method according to claim 1, wherein the substrate is formed of a material selected from the group consisting of polyethylene terephthalate (PET), cyclic olefin copolymer (COP), colorless polyimide (CPI), polyethylene naphthalate (PEN), polycarbonate (PC), and polyethersulfone (PES).

4. The stacking structure preparation method according to claim 1, wherein the silver nanowire layer has a thickness larger than 0.3 μm.

5. A stacking structure, comprising:
a substrate;
a silver nanowire layer disposed on a top of the substrate; and
a metal layer disposed on the top of the substrate and a top of the silver nanowire layer, wherein the metal layer comprises:
a metal mesh, which at least partially covers the substrate and the silver nanowire layer; and
a plurality of metal traces, which is connected to the metal mesh.

6. The stacking structure according to claim 5, wherein the metal layer is formed of a metal material selected from the group consisting of a copper material, a copper-nickel alloy, a copper-lead alloy, a silver material, a silver-nickel alloy, and a silver-lead alloy.

7. The stacking structure according to claim 5, wherein the substrate is formed of a material selected from the group consisting of polyethylene terephthalate (PET), cyclic olefin copolymer (COP), colorless polyimide (CPI), polyethylene naphthalate (PEN), polycarbonate (PC), and polyethersulfone (PES).

8. The stacking structure according to claim 5, wherein the silver nanowire layer has a thickness larger than 0.3 μm.

9. The stacking structure according to claim 5, wherein the stacking structure is divided into:
a trace area, which has the metal traces disposed therein;
a first overlapped area, in which the metal mesh covers only the substrate without covering the silver nanowire layer;
a second overlapped area, which is further divided into an opaque zone, in which the metal mesh covers the silver nanowire layer, and a transparent zone located adjacent to two opposite sides of the metal mesh and covered by the silver nanowire layer but not by the metal mesh; and
a viewable area, which is located adjacent to one side of the metal mesh opposite to the trace area and is covered by the silver nanowire layer but not by the metal mesh.

10. The stacking structure according to claim 9, wherein the transparent zone in the second overlapped area has a covering rate smaller than a covering rate of the opaque zone, and the covering rate of the transparent zone in the second overlapped area is smaller than 50%.

11. The stacking structure according to claim 9, wherein the first overlapped area and the second overlapped area have an overall width smaller than 500 μm and a width-to-width ratio ranging between 0.1 and 10.

12. The stacking structure according to claim 9, wherein the first overlapped area and the second overlapped area have an overall width ranging between 0.5 mm and 1.0 mm and a width-to-width ratio ranging between 0.05 and 20.

13. The stacking structure according to claim 9, wherein the first overlapped area and the second overlapped area have an overall width ranging between 1.0 mm and 1.5 mm and a width-to-width ratio ranging between 0.03 and 30.

14. The stacking structure according to claim 9, wherein the first overlapped area and the second overlapped area have an overall width ranging between 1.5 mm and 2.5 mm and a width-to-width ratio ranging between 0.02 and 50.

15. The stacking structure according to claim 9, wherein the metal mesh in the first overlapped area has a mesh line pitch, which is 0.1 to 10 times as large as a trace pitch of the metal traces.

16. The stacking structure according to claim 9, wherein the metal traces have a trace pitch of 20 μm, a trace width of 10 μm, and a trace spacing of 10 μm, and the metal mesh in the first overlapped area has a mesh line pitch ranging between 2 μm and 200 μm.

17. The stacking structure according to claim 16, wherein the metal mesh in the first overlapped area has a mesh line width ranging between 2 μm and 50 μm and a mesh line spacing ranging between 2 μm and 10 μm.

18. The stacking structure according to claim 17, wherein the metal mesh in the first overlapped area has a mesh line width/mesh line spacing selected from the group consisting of 40 μm/10 μm, 30 μm/10 μm, 20 μm/10 μm, and 10 μm/10 μm.

19. The stacking structure according to claim 9, wherein the metal traces have a trace width ranging between 3 μm and 30 μm and a trace spacing ranging between 3 μm and 30 μm.

20. The stacking structure according to claim 9, further comprising:
a bonding pad disposed on the top of the substrate and comprising a bonding metal mesh.

21. A touch sensor, comprising:
a stacking structure, comprising:
a substrate;
a silver nanowire layer disposed on a top of the substrate; and
a metal layer disposed on the top of the substrate and a top of the silver nanowire layer, wherein the metal layer comprises:
a metal mesh, which at least partially covers the substrate and the silver nanowire layer; and
a plurality of metal traces, which is connected to the metal mesh; and
a cover layer disposed on a top of the metal layer in the stacking structure.

22. The touch sensor according to claim 21, further comprising:
a second silver nanowire layer disposed on a bottom of the substrate;
a second metal layer disposed on the bottom of the substrate and a bottom of the second silver nanowire layer; and
a second cover layer disposed on a bottom of the second metal layer, wherein the second metal layer comprises:
a second metal mesh, which at least partially covers the bottom of the substrate and the second silver nanowire layer; and
a plurality of second metal traces, which is connected to the second metal mesh.
